(19) United States
(12) Patent Application Publication
(10) Pub. No.: US 2016/0368142 A1
(43) Pub. Date: Dec. 22, 2016

(54) CONTROL DEVICE, ROBOT SYSTEM AND METHOD OF GENERATING CONTROL DATA

(71) Applicant: MITSUBISHI HEAVY INDUSTRIES, LTD., Tokyo (JP)

(72) Inventors: Natsuki MATSUNAMI, Tokyo (JP); Tomohiro TAMI, Tokyo (JP); Masato IEHARA, Tokyo (JP); Naoto KAWAUCHI, Tokyo (JP)

(73) Assignee: Mitsubishi Heavy Industries, Ltd., Minato-ku, Tokyo (JP)

(21) Appl. No.: 15/117,562

(22) PCT Filed: Feb. 27, 2015
(86) PCT No.: PCT/JP2015/055863

§ 371 Date: Aug. 9, 2016

(30) Foreign Application Priority Data
Mar. 14, 2014 (JP) 2014-052516

(51) Int. Cl. B25J 9/16

(52) U.S. Cl. CPC B25J 9/1633; G05B 2219/39197

(57) ABSTRACT

An optional position is set as a specification point (10) to a multi-joint manipulator (101). A restrained control command value is calculated to control the multi-joint manipulator in a restrained condition that at least one of degrees of freedom of movement of the multi-joint manipulator is restrained in the specification point, when a control command value to control the multi-joint manipulator is given.

### TECHNICAL FIELD

The present invention relates to a technique of controlling a multi-joint manipulator of a robot.

### BACKGROUND ART

A robot having a multi-joint manipulator (a multi-joint arm) is known. FIG. 1 shows a reference example of the multi-joint manipulator. The multi-joint manipulator 101 has a plurality of links L101 to L106 which are connected in series. A couple of neighbor links (e.g. links L101 and L102) is connected each other through a joint (a joint J102) which is movably provided therebetween. An example of FIG. 1 shows the multi-joint manipulator 101 which has six rotation joints (the joints J101 to J106).

Specifically, one end of a supporting section 103 is attached to a fixed base section 102. One side of a first joint J101 is attached to the other end of the supporting section 103. One end of a first link L101 is attached to the other side of the first joint J101. One side of a second joint J102 is attached to the other end of the first link L101. Hereinafter, in the same way, one side of a sixth joint J106 is attached to the other end of a fifth link. One end of a sixth link L106 is attached to the other side of the sixth joint J106. An end effector 104 is attached to the other end of the link L106.

FIG. 2 is a diagram showing a relation of the joints and the links in the multi-joint manipulator by using symbols. In an example of this diagram, the links L101 to L10n and the joints J101 to J10n are shown.

An operator specifies a position command value on the world coordinate system of a specification point 105 which is set to the tip of the end effector 104 to a control device. The control device calculates an angle command value of each of the joints J101 to J10n to move the specification point 105 to a direction indicated by the position command value. Each of the joints J101 to J10n is driven by a motor and so on according to the angle command value. Through such a control, the distal end (the specification point 105) of the multi-joint manipulator 101 can be moved to a desired position.

In Non-Patent Literature 1, a method of using a linear feedback control and a method of using 2-step control of linearization and servo compensation are described as a position control method for a robot. Also, an obstacle avoidance control in the control of a manipulator has been described in Non-Patent Literature 1.

### CITATION LIST

[Non-Patent Literature 1] “Robot Control Basis Theory”, (Tsuneo Kikkawa), Corona Inc., Published on Nov. 25, 1988

### SUMMARY OF THE INVENTION

As mentioned above, the multi-joint manipulator 101 is often controlled by specifying a position of a distal end. In case of such a control, each of the joints J101 to J10n is automatically controlled based on the calculation to realize the specified distal end position.

By the way, the multi-joint manipulator 101 is sometimes difficult to work only by specifying the position of the distal end. The inventors of the present invention are carrying forward development about the control of the multi-joint manipulator 101 in such a case. FIG. 3 shows an example. When the place where the multi-joint manipulator 101 works is in the back side of an obstacle 106, it is demanded to control the multi-joint manipulator 101 while maintaining the attitude of the multi-joint manipulator 101 moving around the obstacle 106. The attitude of the multi-joint manipulator 101 is maintained to move around the obstacle 106 from the right side of the obstacle 106 in an example of FIG. 3.

FIG. 4 shows another example when it is difficult to work only by specifying the position of the distal end. In this example, the work to a ceiling 109 in a region on the side opposite to a wall 107 is carried out when seeing from the base section 102 of the multi-joint manipulator 101. The link L102 is arranged in a gap 108 of the wall 107. In such a case, it is not sufficient to specify the position of the end effector 104 near ceiling 109, and it is wanted that the link L102 maintains the position of the gap 108.

Note that FIG. 3 and FIG. 4 are diagrams showing examples in which it is difficult to control only by specifying the position of the distal end of the multi-joint manipulator. Therefore, FIG. 3 and FIG. 4 are not diagrams showing prior arts before the application of the present invention.

The control device according to some embodiments is used for the control of the multi-joint manipulator which has the plurality of joints connected through the links. The control device includes a specification point setting section which sets a position except for the distal end as the specification point to the multi-joint manipulator, and a calculating section which generates a restrained control command value to control the multi-joint manipulator in a restrained condition that at least one of degrees of freedom of movement of the multi-joint manipulator in the specification point is restrained, when a control command value to control the multi-joint manipulator is given.

A method of generating control data according to some embodiments generates control data of a multi-joint manipulator which has a plurality of joints connected through links. The method of generating control data includes setting a position except for a distal end as a specification point to the multi-joint manipulator; and generating a restrained control command value to control the multi-joint manipulator in a restrained condition that at least one of degrees of freedom of movement of the multi-joint manipulator in the specification point is restrained, when a control command value to control the multi-joint manipulator is given.

A robot system according to some embodiments includes a multi-joint manipulator which has a plurality of joints connected through links; a control device which carries out specification point setting processing and restrained control command value calculating processing. The specification point setting processing is processing of setting a position except for a distal end as the specification point to the multi-joint manipulator. The restrained control command value calculation processing is processing of calculating a restrained control command value to control the multi-joint manipulator in a restrained condition that at least one of degrees of freedom of movement of the multi-joint manipulator in the specification point is restrained, when a control command value to control the multi-joint manipulator is given. The control device transmits the restrained control command value to the multi-joint manipulator.

An appropriate control becomes possible in the environment in which it is difficult to control only by specifying the position of the distal end of the multi-joint manipulator.

### BRIEF DESCRIPTION OF THE DRAWINGS

The attached drawings are incorporated into this specification to help the description of the embodiments. Note that the drawings should not be used to interpret the present invention to limit to examples shown in the drawings and described.

[FIG. 1]

FIG. 1 shows a multi-joint manipulator in a reference example.

[FIG. 2]

FIG. 2 is a diagram showing a relation between joints and links in the multi-joint manipulator with symbols.

[FIG. 3]

FIG. 3 shows an example when there is an obstacle.

[FIG. 4]

FIG. 4 shows another example when there is an obstacle.

[FIG. 5]

FIG. 5 shows the multi-joint manipulator according to an embodiment.

[FIG. 6]

FIG. 6 shows a flow chart of control of the joints.

[FIG. 7]

FIG. 7 shows functional blocks implemented by a control computer.

[FIG. 8]

FIG. 8 shows a specification point shown on a link.

[FIG. 9]

FIG. 9 shows the specification point shown on the link.

[FIG. 10]

FIG. 10 shows the specification point shown on the link.

[FIG. 11]

FIG. 11 shows the multi-joint manipulator holding an object.

[FIG. 12]

FIG. 12 is a diagram of the multi-joint manipulator to explain a distal end fixation control.

[FIG. 13]

FIG. 13 is a flow chart of the distal end fixation control and a base fixation control.

[FIG. 14]

FIG. 14 is a diagram showing the distal end fixation control.

[FIG. 15]

FIG. 15 is a diagram showing the distal end fixation control.

[FIG. 16A]

FIG. 16A is a diagram showing a method of setting a specification point.

[FIG. 16B]

FIG. 16B is a diagram showing the method of setting the specification point.

[FIG. 16C]

FIG. 16C is a diagram showing the method of setting the specification point.

[FIG. 17A]

FIG. 17A is a diagram showing the method of setting the specification point.

[FIG. 17B]

FIG. 17B is a diagram showing the method of setting the specification point.

[FIG. 17C]

FIG. 17C is a diagram showing the method of setting the specification point.

### DESCRIPTION OF EMBODIMENTS

Hereinafter, embodiments will be described with reference to the attached drawings. In the following detailed description, to provide the comprehensive understanding of the embodiments, many detailed specific items are disclosed for the purpose of description. However, it would be clear that one or plural embodiments can be realized without these detailed specific items.

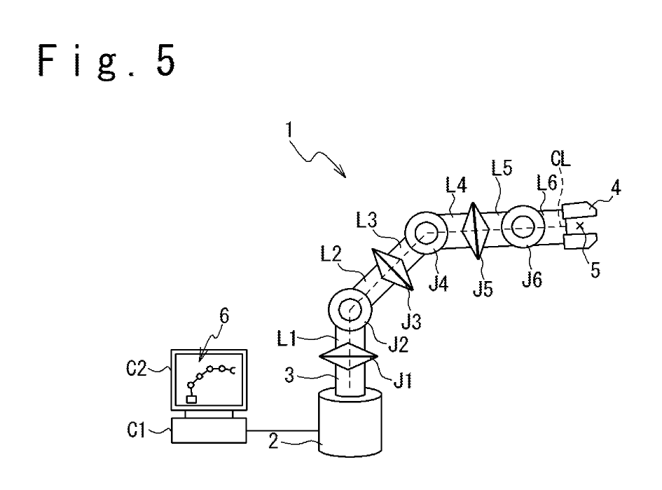

FIG. 5 shows a robot system according to an embodiment that includes a multi-joint manipulator 1, a computer C1 (a control device of the multi-joint manipulator) and a display device C2. The multi-joint manipulator 1 is composed of a base section 2 fixed on a floor and so on. One end of a supporting section 3 is fixed on the base section 2. The other end of the supporting section 3 is attached to one side of a joint J1. One end of a first link L1 is attached to the other side of the joint J1. One side of a second joint J2 is attached to the other end of the first link L1. Likewise, one side of a sixth joint J6 is attached to the other end of a fifth link. One end of a sixth link L6 is attached to the other side of the sixth joint J6. An end effector 4 is attached to the other end of the sixth link L6. The multi-joint manipulator 1 having six joints J1 to J6 is shown in an example of FIG. 5. However, the multi-joint manipulator 1 of n degrees of freedom having n joints J1 to Jn (n is a natural number equal to or more than one) which is more or less than the above number.

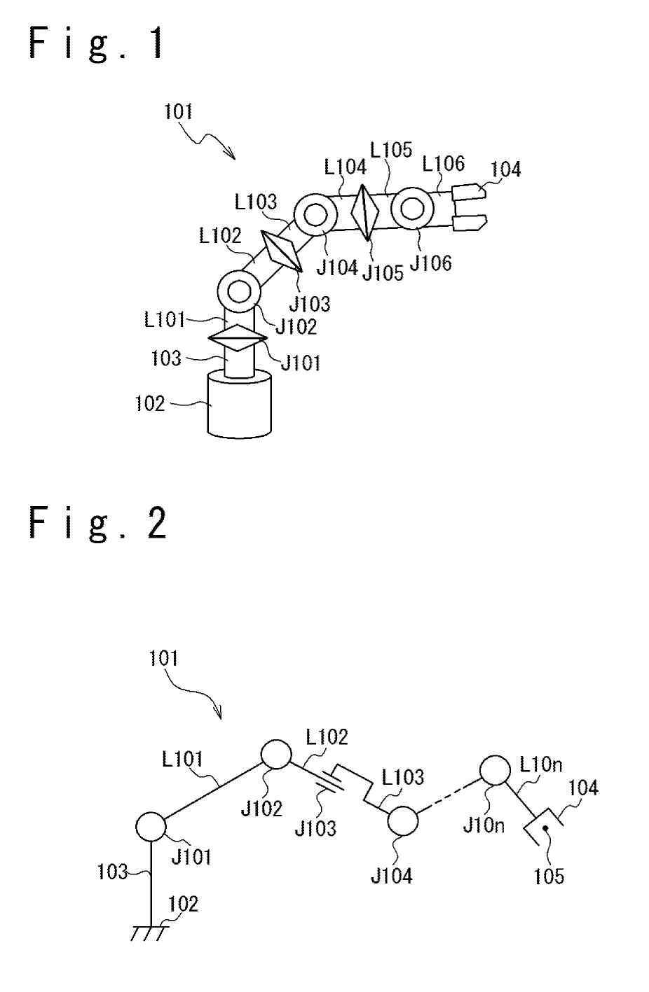

Like a reference example described with reference to FIG. 1 and FIG. 2, an operator specifies a position command value and an attitude command value (final target value) to the control device. The position command value shows a desired position (travel target position) on a world coordinate system of a specification point 5 set for a distal end of the multi-joint manipulator 1 (a tip of the end effector 4 and so on), and the attribute command value shows a desired attitude (a target attitude). The control device generates an angle command value of each of the joints J1 to J6 for the specification point 5 to head for a state shown by the position command value and the attitude command value. Each of the joints J1 to J6 is driven by a motor and so on in response to an angle command value. By such a control, the distal end of the multi-joint manipulator 1 (the specification point 5) can be moved to the desired position.

The computer C1 is connected with the multi-joint manipulator 1. The computer C1 is composed of a non-transitory recording medium such as a hard disk. The computer C1 executes a software program stored in the recording medium and can carry out a virtual display of the state or operation of the multi-joint manipulator 1 (in a simulation display) on the display device C2. The operator can previously confirm the state or operation of the multi-joint manipulator 1 on a screen of the display device C2 by a simulation display. The operator can see an image 6 of the multi-joint manipulator 1 displayed on the screen, specify the specification point 5 on the screen, move a part of the multi-joint manipulator 1 corresponding to the specification point 5 on the screen, and specify the attitude of the part of the multi-joint manipulator 1 in the specification point on the screen, by using a graphical user interface such as Pointer 14 and Interactive Marker to be described later. For example, through such a screen operation, a control command value (the position command value and/or the attitude command value) of the distal end of the multi-joint manipulator 1 can be set.

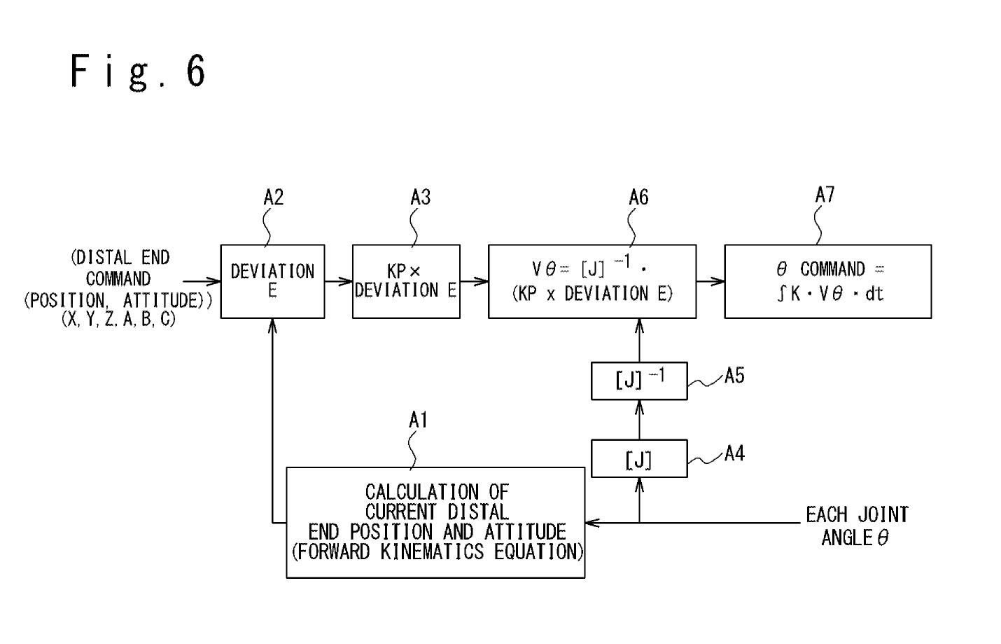

FIG. 6 shows a general flow of the control of the joints J1 to J6 when the command value of the specification point 5 is inputted. The multi-joint manipulator 1 can detect a joint angle θ showing a current attitude of each of the joints J1 to J6 by an encoder and so on. The computer C1 acquires a current value of the joint angle θ of each of the joints J1 to J6 from the multi-joint manipulator 1. The computer C1 carries out the calculation of forward kinematics based on the joint angles θ, to calculate a current distal end position and a current distal end attitude on the world coordinate system (A1).

On the other hand, the operator uses the computer C1 to input a distal end command indicating a target position of the specification point 5 and a target attitude there while viewing the simulation image on the display device C2. The computer C1 calculates a deviation E (including, for example, a position deviation or an attitude deviation) of the distal end position and attitude specified by the distal end command from the current distal end position and attitude calculated in A1 (A2). Furthermore, the computer C1 multiplies the deviation E by a proportional gain KP for the position control set previously (A3).

A Jacobian matrix [J] is calculated based on a detection value of the current angle of each of the joints J1 to J6 (A4). Moreover, an inverse matrix of the Jacobian matrix is calculated (pseudo inverse matrix when the multi-joint manipulator 1 has redundant degrees of freedom) (A5). Using this inverse Jacobian matrix [J]⁻¹, a command value (Vθ) of a joint speed is calculated from the position attitude deviation KP·E which have been multiplied by the gain (A6). By integrating the command value of this joint speed (a joint angular speed) with respect to time, the command value of the joint angle is calculated (A7). Note that “K” in A7 of FIG. 6 is a coefficient. For example, the coefficient K is set to K=1. The computer C1 transmits the command value of the joint angle to the multi-joint manipulator 1. An operation control unit of the multi-joint manipulator 1 controls motors of each of the joints J1 to J6 and so on based on the command value. Through the above control, the end effector 4 can be operated to take the target position and the target attitude which are specified by the operator.

### Fixation of Link Position

The above is a description about the control to move the distal end of the multi-joint manipulator (the specification point 5) to the target position and the target attitude. In addition to it, in the present embodiment, a position except for the distal end (the specification point 5) is sets as a specification point 10 to the multi-joint manipulator 1. Then, a partial fixation control is carried out in which the position and attitude of the distal end are controlled in a restrained condition that at least one of degrees of freedom of operation of the multi-joint manipulator 1 in the specification point 10 is restrained. In the partial fixation control of the present embodiment, the end effector 4 is operated in the condition that a position of the specified one of the links L1 to L6 is fixed. Hereinafter, such a control will be described.

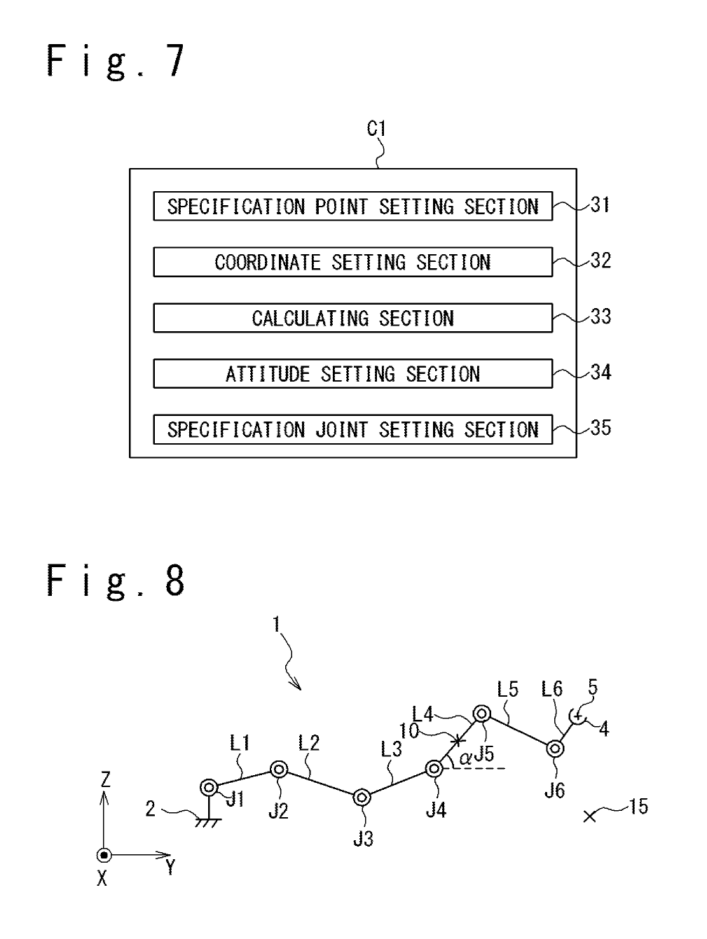

FIG. 7 shows functional blocks which are implemented by the computer C1 to carry out such a control. The computer C1 functions as a specification point setting section 31, a coordinate setting section 32, a calculating section 33, an attitude setting section 34 and a specification joint setting section 35. Each of these functional blocks is implemented by a processing unit of the computer C1 reading and executing a software program stored in a recording medium.

The computer C1 executes the above-mentioned program to carry out specification point setting processing, current position data generation processing, restrained control command value calculation processing, specification attitude setting processing, object data acquisition processing, object image display processing, specification joint setting processing, reference coordinate setting processing, fixation-side length calculation processing, traveling destination setting processing, movable-side joint control command value generation processing, fixation-side joint control command value generation processing and so on.

The specification point setting section 31 carries out the specification point setting processing of setting an optional position on the multi-joint manipulator 1 as the specification point 10. Specifically, the operator carries out an input operation of operating a pointer displayed on the screen and specifying a desired position of an image 6 of the multi-joint manipulator (the image of the multi-joint manipulator on the display device C2). The specification point setting section 31 sets the specification point 10 according to the input operation. For example, the specification point 10 is specified in a robot coordinate system (a local coordinate system of the multi-joint manipulator 1). Such a specification can be carried out based on a link number and a relative position from a link original point as described later.

As an example of the specification point, the specification point 10 is shown on the link L4 in FIG. 8. The operator can set the specification point 10 to the desired position by operating (an input device of) the computer C1 while viewing the image 6 of the multi-joint manipulator. In an example of FIG. 8, an optional position of the multi-joint manipulator 1 on the side of the distal end from the joint J1 can be set as the specification point 10 because the components of the multi-joint manipulator 1 on the side of the distal end from the first joint J1 are movable.

Data that is important typically as position data for specifying the specification point 10 is a position on the manipulator in a length direction (in other words, a position in the length direction of the links L1 to L6). Therefore, the operator can specify, as the specification point 10, an optional position on a centerline CL in a movable section (on the side of the distal end from the first joint J1) when a virtual centerline CL from the base section 2 of the multi-joint manipulator 1 toward the end effector 4 (reference to FIG. 5) is drawn to pass through the center of each of the links L1 to L6.

Such a specification point 10 can be specified based on the link number and a distance from the link origin in the length direction. The link number is an identifier which specifies each link individually (for example, “L4” of the links L1 to L6 in FIG. 8). The position from the link origin shows a length from a predetermined position on the side of the base section of the link L4 set with the specification point 10 (e.g. a position of the connection part of the joint J4 and the link L4 in FIG. 8) to the specification point 10.

The coordinate setting section 32 sets the specification position showing a fixation position of the specification point 10 in the world coordinate system (shown by the xyz coordinates in FIG. 8) in relation to the specification point 10. Specifically, like the already described case of setting the specification point 10, the coordinate setting section 32 sets the specification position based on the input operation by the operator.

The calculating section 33 carries out the current position data generation processing of generating data showing the current position of the specification point 10 based on a detection value supplied from the multi-joint manipulator 1 (each joint angle θ). The calculating section 33 generates a command value to operate (move or travel) the specification point 10 from the current position to the specification position. The generated command value is transmitted to the multi-joint manipulator 1 (the operation control unit of the multi-joint manipulator). The multi-joint manipulator 1 drives the joints J1 to J6 based on the command value to operate the specification point 10 to the specification position (in other words, the operation control unit of the multi-joint manipulator transmits a control command value to a motor corresponding to each joint and so on, such that the motor drives the joint).

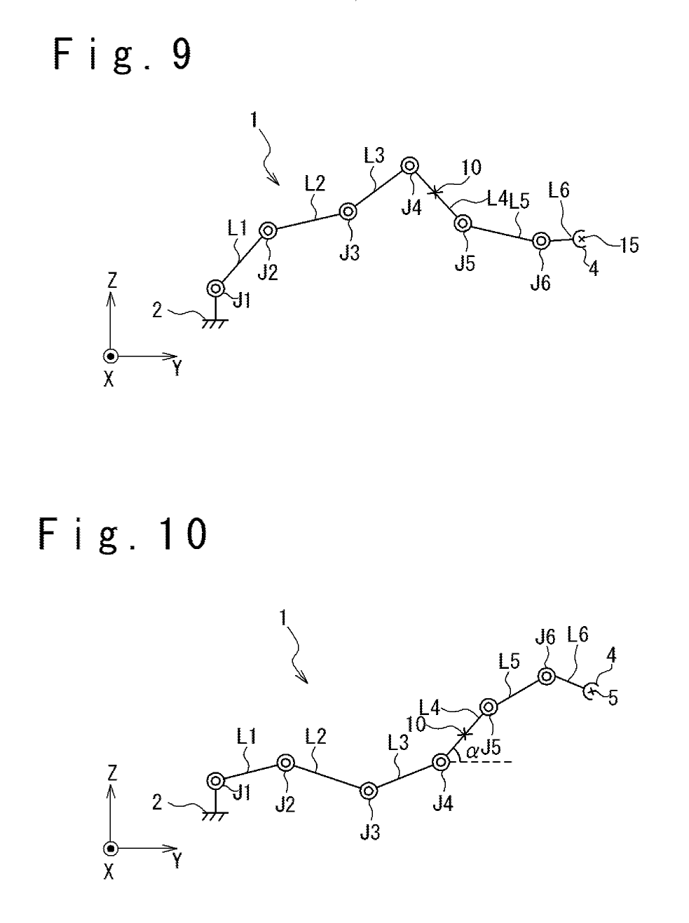

The calculating section 33 carries out the restrained control command value calculation processing of calculating a command value (the restrained control command value) for controlling the position and attitude of the distal end of the multi-joint manipulator 1 in the condition that the specification point 10 is fixed on the specification position. In the restrained control command value calculation processing, when the operator inputs the target position 15 of the specification point 5 in the distal end, the calculating section 33 calculates a control command value (the restrained control command value) to each of the joints J1 to J6 such that the specification point 5 of FIG. 8 moves to the target position 15 to take the attitude shown in FIG. 9. The calculation is realized by dividing the joints into two parts of the joints J1 to J4 on the side of the base section from the specification point 10 and the joints J5 and J6 on the side of the distal end, and by using the forward kinematics calculation and the inverse kinematics calculation shown in FIG. 6 to each of the two parts independently.

In the above, the method of generating the control data of the multi-joint manipulator in the present embodiment 1 has been described. The computer C1 transmits the control data to the multi-joint manipulator 1 (the operation control unit of the multi-joint manipulator) such that the control of the multi-joint manipulator 1 is carried out in the condition that the specification point 10 is fixed on the specification position.

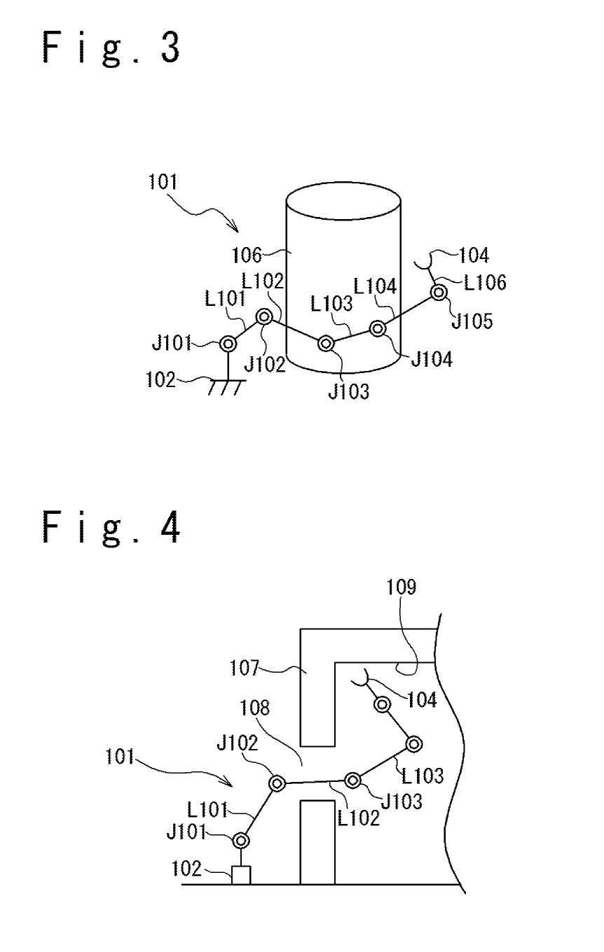

If the degrees of freedom on the side of the distal end is enough as in case that the number of joints on the side of the distal end from the specification point 10 is equal to or more than six (joints J5 and J6 in the example of FIG. 8 and FIG. 9), the target position and the target attitude can be freely set to the specification point 5. When the degrees of freedom on the side of the distal end from the specification point 10 is not enough, the operator can set a target position and a target attitude in the range of the degrees of freedom. Through such a control, when an obstacle as shown in FIG. 3 exists around it, or when the link L4 should not be moved to pass through a gap 108 as shown in FIG. 4, the distal end can be controlled by fixing the link L4.

### Fixation of Link Position and Attitude

In the partial fixation control, moreover, the control of the multi-joint manipulator can be carried out in the condition that the attitude of the multi-joint manipulator 1 in the specification point 10 is fixed in addition to the position of the specification point 10. In such a case, the attitude setting section 34 of FIG. 7 carries out the specification attitude setting processing of setting a specification attitude according to the angle inputted by the operator viewing the image 6 of the multi-joint manipulator. For example, by this operation, the angle of the link L4 is fixed to a value indicated with the specification attitude. In FIG. 8, the specification attitude is shown as an angle α. FIG. 8 is shown in planar manner, but the specification attitude indicates a three-dimensional angle, when the multi-joint manipulator 1 carries out a three-dimensional operation, and the specification attitude is specified by an Eulerian angle set on the world coordinate.

In such a case, the calculating section 33 calculates the command value to control the operation of the multi-joint manipulator 1 in the condition that the multi-joint manipulator 1 is fixed on the specification position in the specification point 10 and the attitude is fixed on the specification attitude. By transmitting this command value to (the operation control unit of) the multi-joint manipulator 1, the multi-joint manipulator 1 can be controlled in the condition that the position of the specification point 10 of the specified link L4 is fixed, as shown in FIG. 10, and that the attitude (angle α) of the link L4 in the specification point 10 is fixed.

### Fixation of Object

In the partial fixation control, it is possible to carry out an object fixation control in which a position except for any position on the multi-joint manipulator 1 is set as the specification point 10. FIG. 11 shows an example. In this example, the end effector 4 supports the object 11 such as a tool. The specification point 10 is set on the object 11.

Even if the specification point 10 is set to such a position, the calculating section 33 can generate a restrained control command value in the condition that the position and attitude of the object 11 is fixed in the specification point 10. However, the position and attitude of the object 11 to the link L6 to which the end effector 4 has been attached are supposed to be fixed. By such a control, when not the distal end of the multi-joint manipulator 1 but the position and attitude of the tip of the object held by the end effector 4 is to be fixed, the specification point can be easily set.

In case of this control, the operator specifies a desired portion of the links L1 to L6 or the joints J1 to J6. Moreover, the operator specifies a target position and/or a target attitude of that portion. The calculating section 33 calculates an angle of each of the joints J1 to J6 such that the specified portion heads for the target position and/or the target attitude, in the restrained condition that the specification point 10 on the object 11 has been fixed on the specified position in the world coordinate system.

In case of the object fixation control, the specification point 10 can be set as follows. A link number and a relative position in the world coordinate system to the link origin of a link corresponding to the link number are set. In case of FIG. 11, “link L6” is set as the link number and the relative position of the target value of the specification point 10 to the link origin is set. At this time, if the relative position to the link origin is set on the distant side farther than the tip of the link L6 and the end effector 4, the specification point 10 is supposed to be set on the object 11 held by the end effector 4.

The specification point 10 can be set as follows. In a robot head and so on which the multi-joint manipulator 1 has, a detector which can detect the shape of the object near the end effector 4 is provided (e.g. a laser scanner, and the detector is not shown). The detector detects the position, shape and attitude of the object 11. The detector transmits a detection signal corresponding to the position, shape and attribute of the object 11 (the detected object data or the object data acquired by the detection) to the computer C1. The computer C1 receives the detection signal (the object data) from the detector. The computer C1 carries out the object data acquisition processing of acquiring the object data (data of the position, shape and attitude of the object) based on the received detection signal.

The computer C1 carries out the object image display processing of displaying the object image on the display device C2 based on the acquired object data. That is, the simulation image of the multi-joint manipulator 1 is displayed on the display device C2 in the condition that the object 11 is held in an actual space. The operator sees the image of the object 11 on the screen and carries out an input operation of setting the specification point 10 on the object image by a pointer and so on. The specification point setting section 31 sets the specification point 10 according to the input operation.

### Distal End Fixation Control

Next, as one embodiment, a distal end fixation control and a base fixation control will be described. Either of these controls is same as the embodiments described with reference to FIG. 5 to FIG. 11, in that at least one of the degrees of freedom of movement of the multi-joint manipulator 1 is restrained in the specification point. However, the present embodiment is different from the embodiments described with reference to FIG. 5 to FIG. 11, in that a joint (the joint corresponding to the specification point) is selected, and all the joints provided on one of the before side and after side of the selected joint (on either side of the base side and the distal end side) are fixed. In the embodiments described with reference to FIG. 5 to FIG. 11, the control is carried out in which a position of the specification point 10 in the world coordinate system is fixed. However, in the present embodiment, the control is carried out in which an angle between two links connected to one joint on the base side or the distal end side is fixed.

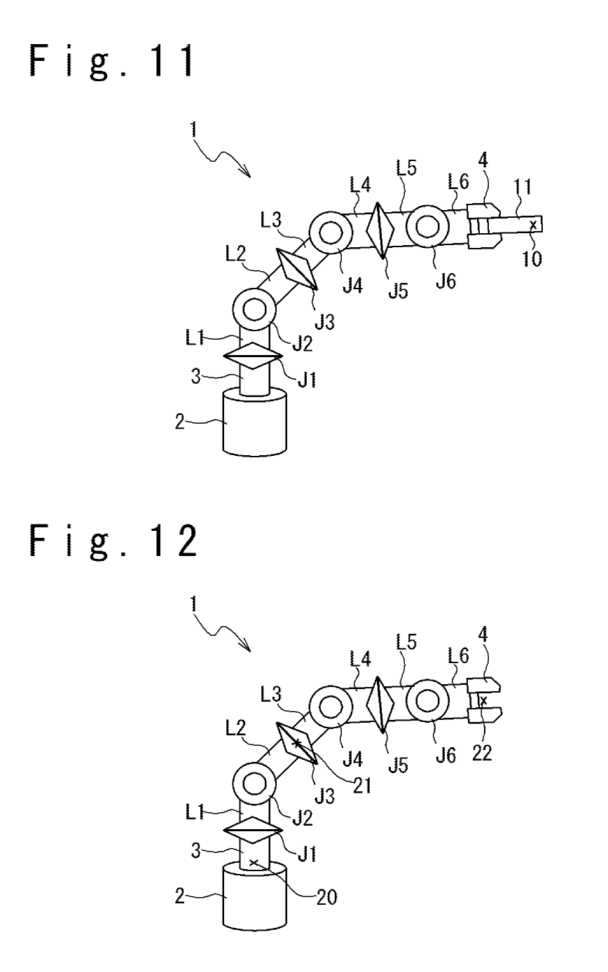

First, the distal end fixation control will be described. In case of this control, the control is carried out in the condition that all the joints in a part of the multi-joint manipulator 1 on the distal end side from some joint are fixed. Referring to FIG. 12, this control will be described. In the present embodiment, a fixed position of the base section of the multi-joint manipulator 1 (such as the connection section between the base section 2 and the supporting section 3) is referred to as an “absolute reference coordinates 20”, a position of a specification joint specified by the operator (the joint J3 in FIG. 12) is referred to as an “setting coordinates 21”, and a position of the distal end of the multi-joint manipulator 1 such as the fixed position on the end effector 4 is referred to as a “distal end coordinates 22”.

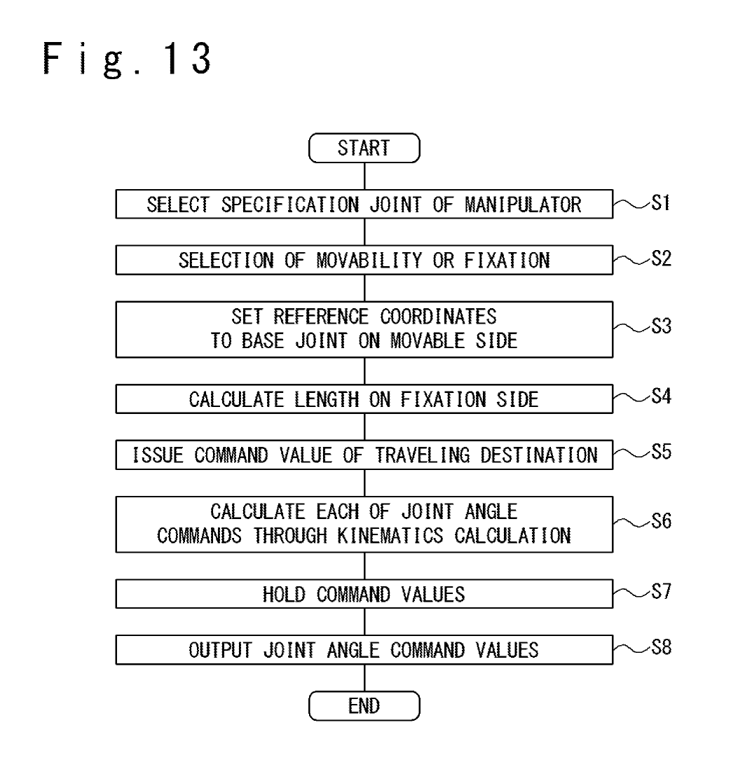

FIG. 13 is a flow chart showing processing of the distal end fixation control and the base fixation control. First, the operator carries out an input operation to the computer C1 (an input operation using an input device) to select one of a plurality of joints J1 to J6 of the multi-joint manipulator 1 as the specification joint. The specification joint setting section 35 of FIG. 7 carries out specification joint setting processing of setting the specification joint according to the input operation. Note that the specification joint setting processing is one example of the specification point setting processing. In an example of FIG. 12, the joint J3 is set as the specification joint. The position of the specification joint in the world coordinate system is the “setting coordinates 21” (Step S1).

Next, which of the base and the distal end is fixed is selected. In the present embodiment, the distal end fixation control is selected according to the input operation to the computer C1 by the operator. By this selection, the base side from the “setting coordinates 21” is a movable side and the distal end side from the “setting coordinates 21” is a fixation side (Step S2).

Next, the calculating section 33 sets the position of the base section on the movable side as the reference coordinates (in other words, the calculating section 33 carries out reference coordinates setting processing of setting the position of the base section on the movable side as the reference coordinate). Because the base side is the movable side in case of the distal end fixation control, the “absolute reference coordinates 20” corresponding to the base section of the whole multi-joint manipulator 1 are set as the reference coordinates (Step S3).

Next, the calculating section 33 calculates a length on the fixation side (in other words, the calculating section 33 carries out fixation side length calculation processing of calculating the length on the fixation side). In an example of FIG. 12, the length in the world coordinate system from the “setting coordinates 21” of the specification joint to the “distal end coordinates 22” of the end effector 4 is calculated. The calculation is possible as follows. The computer C1 reads a current detection value of a joint angle of each of the joints J3 to J6 on the fixation side. Moreover, because data of a simulation model such as link parameters of the multi-joint manipulator 1 are registered on the computer C1, the length of each of the links L1 to L6 can be known. Therefore, each of the lengths between the “setting coordinates 21” and the “distal end coordinates 22” in the X-axis direction, the Y-axis direction, and the Z-axis direction in the world coordinate system is calculated based on the detection values of the joint angles on the fixation side and the length of each of the links L3 to L6. The length of the fixation side in each of the X-axis direction, the Y-axis direction, and the Z-axis direction is obtained through this computation (Step S4).

Next, the coordinates setting section 32 carries out traveling destination setting processing of setting a traveling destination of the setting coordinates 21 as specification coordinates (Step S5). The calculating section 33 carries out movable side joint control command value generation processing of generating a control command value of each of the joints J1 and J2 on the movable side (one example of the restrained control command value generation processing) based on the inverse kinematics calculation such that the setting coordinates 21 is moved to the specification coordinates (Step S6). Although only two joints J1 and J2 on the movable side are shown in FIG. 12, it is desirable to prepare more joints actually so as to make such movement possible. Next, the calculating section 33 carries out fixation side joint angle command value generation processing of fixing an angle command value of each of the joints J3 to J6 on the fixation side (from the setting coordinates 21 to the distal end coordinates 22) to a constant value (one example of the restrained control command value generation processing). Through such processing, the restrained control command value is generated (Step S7).

The computer C1 transmits a command value of an angle of each of the joints J1 to J6 generated in the above processing to the multi-joint manipulator 1. Each of the joints J1 to J6 of the multi-joint manipulator 1 is driven based on the command value (Step S8).

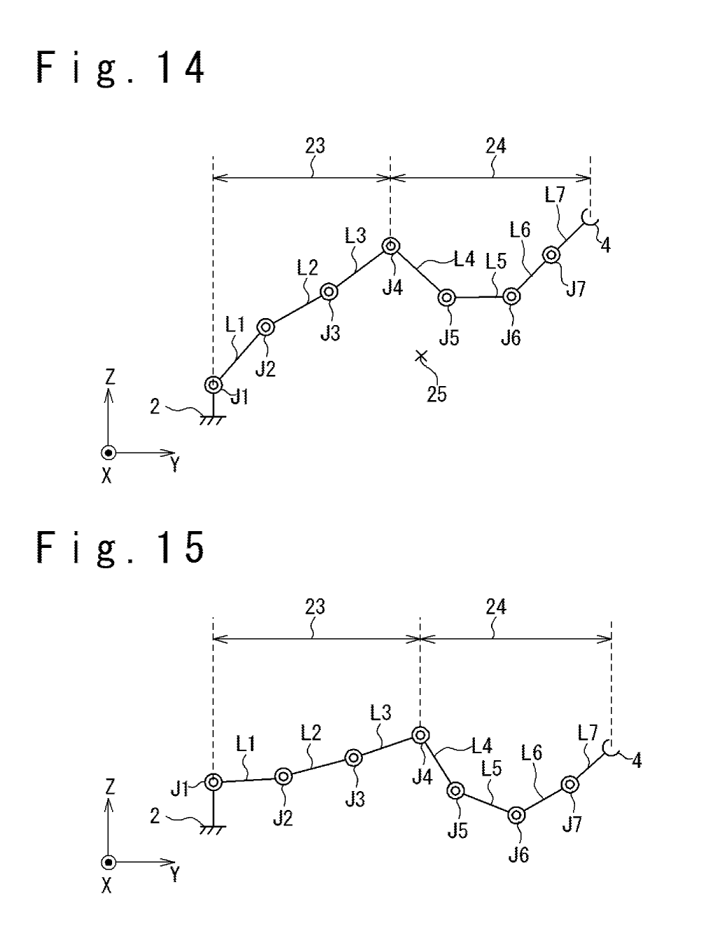

FIG. 14 and FIG. 15 show an example of the operation of the multi-joint manipulator 1 in case of the distal end fixation control. The joint J4 is supposed to be set as the specification joint in FIG. 14. A base side 23 from the joint J4 is a movable side, and a distal end side 24 therefrom is a fixation section. FIG. 15 shows the multi-joint manipulator 1 after the specification joint is moved based on the command value set at step S5. The specification joint J4 has been moved to the specification point 25. At this time, because the angle of each of the joints J4 to J7 on the distal end side 24 is fixed, the relative positions of the links L3 to L7 and an attitude thereof are fixed. That is, a portion of the multi-joint manipulator 1 from the link L3 to the end effector 4 is fixed in the shape, and can be used as an end effector of a kind held by the movable section on the distal end side 24.

Generally, the position of the distal end of the end effector 4 in the world coordinate system is an object to be controlled for some work. The position can be known by adding the coordinates of the specification joint J4 and the length on the distal end side 24 calculated at step S4.

### Base Fixation Control

Next, the base fixation control will be described. In case of this control, the control is carried out in the condition that all the joints in a portion of the multi-joint manipulator 1 on the base side from some joint are fixed. Referring to FIG. 13 again, the base fixation control will be described. The selection of the specification joint at step S1 is same as the distal end fixation control. At step S2, the base fixation control is selected according to the input operation of the computer C1 by the operator. Through this selection, the base side from the “setting coordinates” is set as the fixation side and the distal end side thereform is set as the movable side (Step S2).

Next, the calculating section 33 sets the position of the base on the movable side as the reference coordinates (in other words, the calculating section 33 carries out reference coordinate setting processing of setting the position of the base on the movable side as the reference coordinates). In case of base fixation control, because the distal end side is the movable side, the “setting coordinates 21” corresponding to the base on the distal end side is set as the reference coordinates (Step S3).

Next, the calculating section 33 calculates a length on the fixation side (in other words, the calculating section 33 carries out fixation side length calculation processing of calculating the length on the fixation side). In an example of FIG. 12, the length from the “absolute reference coordinates 20” to the “setting coordinates 21” of the specification joint is calculated. The calculating method is same as in case of the distal end fixation control (Step S4).

Next, the coordinates setting section 32 carries out the traveling destination setting processing of setting a traveling destination of the setting coordinates 21 as the specification coordinates (Step S5). The calculating section 33 carries out movable side joint control command value generation processing of generating the control command value of each of the joints J4, J5, and J6 on the movable side (an example of the restrained control command value generation processing) based on the inverse kinematics calculation for the setting coordinates 21 to be traveled to the specification coordinates (Step S6). Next, the calculating section 33 carries out fixation side joint control command value generation processing of fixing the angle command value of each of the joints J1, J2, and J3 on the fixation side (from the absolute reference coordinates 20 to the setting coordinates 21) to a constant value (one example of the restrained control command value generation processing) (Step S7).

The computer C1 transmits a command value of the angle of each of the joints J1 to J6 generated in the above processing to the multi-joint manipulator 1. Each of the joints J1 to J6 of the multi-joint manipulator 1 is driven based on the command value (Step S8).

Through the above processing, the base fixation control in which each of the joints J4 to J7 on the distal end side 24 operates becomes possible in the condition that each of the joints J1 to J3 on the base side 23 shown in FIG. 14 is fixed. By such a control, for example, when there is an obstacle 106 as shown in FIG. 3, the attitude of the joints J1 to J3 is fixed so that these joints turn around the obstacle 106, and the joints J4 to J7 on the distal end side 24 are moved and operated to a region on the opposite side.

As an application of the above-mentioned distal end fixation control and base fixation control, the operation of only a single specification joint may be fixed. In such a control, the relative positions and the relative attitude of a couple of links connected with the specification joint are fixed and the control of the other joints is carried out.

### Method of Setting

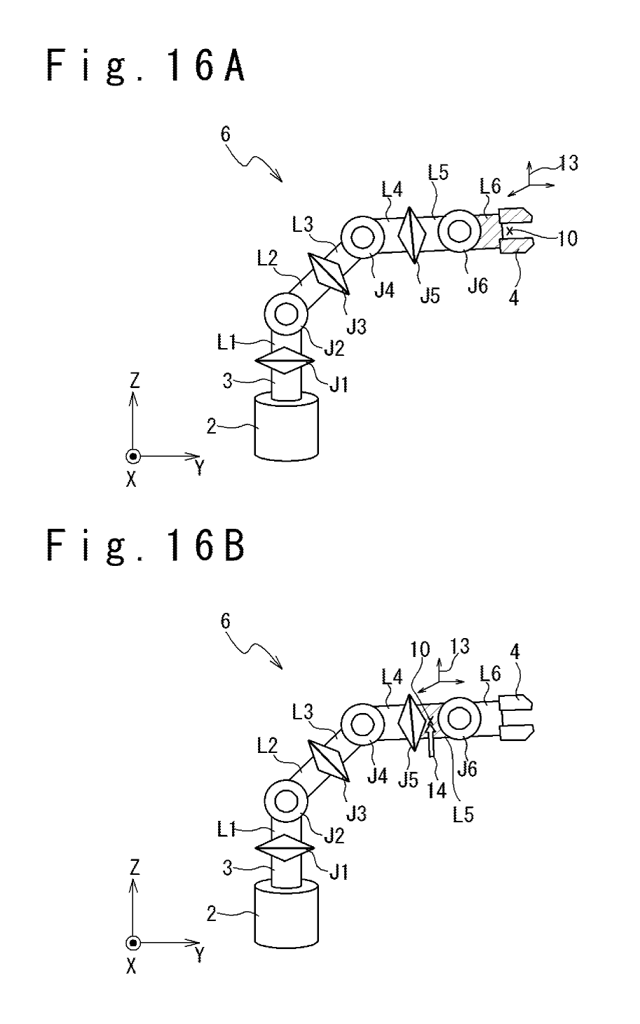

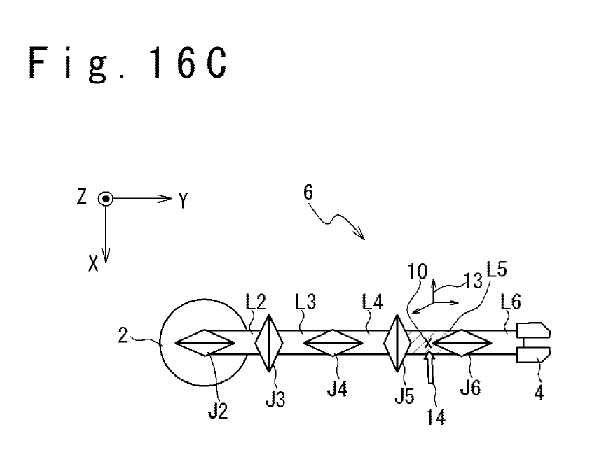

Next, a method of setting the specification point 10 will be described. FIG. 16A shows an example of a screen of the display device C2 of FIG. 5. In an example of FIG. 16A, an image 6 of the multi-joint manipulator 1 is shown which is seen from the X-axis direction of the rectangular coordinate system of the three axes of XYZ. The link L6 having the end effector 4 in the distal end is selected in a default condition. The selected link L6 is displayed (e.g. in a different color) to distinguish visually from the other part.

In the default condition, the specification point 10 is displayed in the distal end position (the predetermined position on the end effector 4). A marker 13 is displayed to show the three-dimensional attitude of the selected link L6 in the position of the specification point 10. The interactive Marker of ROS (Robot Operating System) which is a middleware developed by Willow Garage Inc. can be used as the marker 13.

The pointer 14 which can be operated by a pointing device such as a mouse is displayed on the screen. The operator operates the pointer 14 to specify a desired link of the multi-joint manipulator image 6 for a selection operation. FIG. 16B shows a screen on which the selection operation was carried out. The link L5 is selected and is displayed in a color which is different from the other links L1 to L4, and L6. The operator puts the tip of the pointer 14 on a desired position for a specification operation. According to the specification operation, a part of the tip of the pointer 14 is specified as the specification point 10.

The marker 13 is displayed near the specification point 10 to show the attitude of the selected link L5. The marker 13 has arrows of three axes of XYZ and an angle can be freely set in the three-dimensional space. The operator specifies the marker 13 by the pointer 14 and sets the attitude of the link L5 by rotating to a desired angle on the screen.

The whole multi-joint manipulator image 6 may be displayed once more according to the setting of the attitude of the link L5. In this case, the calculating section 33 carries out the forward kinematics calculation and the inverse kinematics calculation according to the attitude which has been set by using the marker 13 to calculate the angle of each of the joints J1 to J6, and displays the multi-joint manipulator image 6 after changing the attitude of the link L5 into the setting attitude.

The operator can freely change the position and the angle of s virtual viewpoint to see the multi-joint manipulator image 6. FIG. 16B shows the multi-joint manipulator image 6 which is seen from the X-axis direction, and FIG. 16C shows the multi-joint manipulator image 6 which is seen from the Z-axis direction by changing the virtual viewpoint. In this state, the operator can carry out the selection of the link L5 and the specification of the attitude of the link L5 by operating the pointer 14 and the marker 13. In this way, by seeing the image 6 of the attitude of the multi-joint manipulator in a virtual space from various viewpoints, the attitude of the selected link L5 can be easily set.

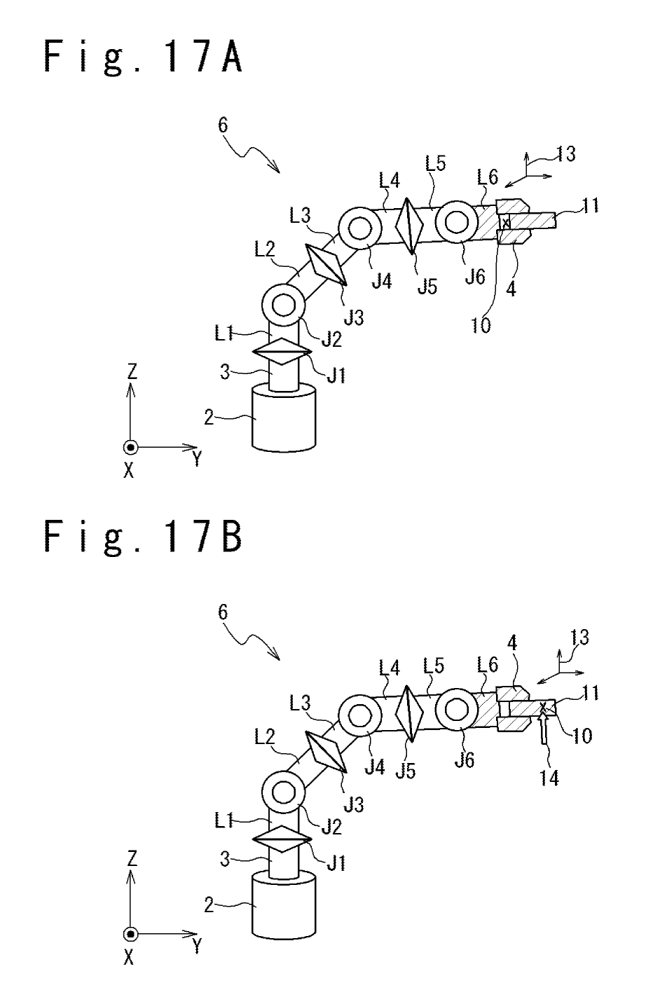

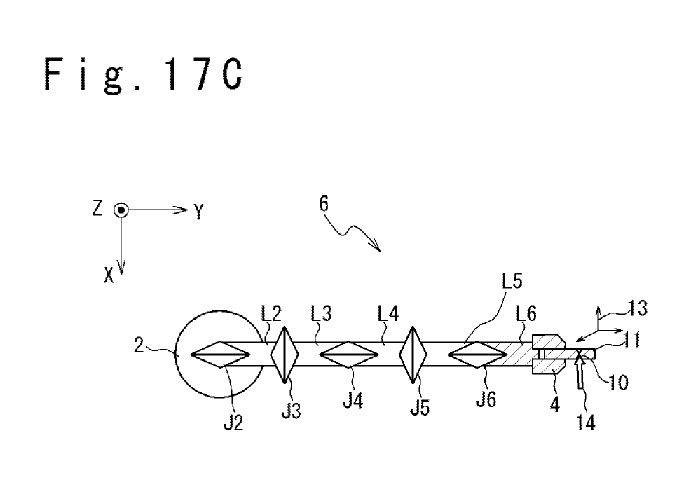

Next, a method of setting the partial fixation control to fix the object 11 described with reference to FIG. 11 will be described. FIG. 17A shows a multi-joint manipulator image 6 when the end effector 4 holds the object 11. As previously described, the shape, size and attitude of the object 11 can be detected by a laser scanner and so on. Based on the detection result, the object 11 is displayed as a part of the multi-joint manipulator image 6. The multi-joint manipulator image when the link L6 of the distal end is selected is displayed in the default condition. In this case, the object 11 is displayed in a different color from the other part in addition to the link L6 on the distal end side. The specification point 10 is displayed in the position of the distal end and the marker 13 is displayed near it.

As shown in FIG. 17B, the operator operates the pointer 14 to set a desired position on the object 11 as the specification point 10. This position of the specification point 10 can be specified based on data showing a link number (the link L6) and a relative position from the link origin, as described with reference to FIG. 11. The operator operates the marker 13 displayed in the neighborhood of the specification point 10, to set the attitude of the object 11. As shown in FIG. 17C, the operator can set the attitude of the object 11 by seeing the object 11 from various angles while freely changing the position and angle of the virtual viewpoint on the screen.

The present invention is not limited to each of the above embodiments. It would be clear that each of the embodiments may be changed and modified appropriately in a range of features of the present invention. Also, various techniques used in the embodiments or the modification examples can be applied to another embodiment or a modification example, unless there is not any technical contradiction.

This application is based on Japanese Patent Application JP 2014-52516 filed on Mar. 14, 2014 and claims the priority of that application. The disclosure of that application is incorporated herein by reference.

1. A control device for a multi joint manipulator which has a plurality of joints connected through links, comprising:
a specification point setting section which sets a position except for a distal end as a specification point to the multi-joint manipulator;
a coordinate setting section which sets a specification position corresponding to the specification point and
a calculating section which generates a restrained control command value to control the multi joint manipulator in a restrained condition that at least one of degrees of freedom of movement the multi joint manipulator in the specification point is restrained, when a control command value to control the multi joint manipulator is given,
wherein the restrained condition is a condition that the multi-joint manipulator in the specification point is fixed on the specification position.

2. The control device according to claim 1,
wherein the specification point is on any of the links, and
wherein the restrained condition is a condition that a position or attitude of one of the links on which the specification point is set is fixed.

3. The control device according to claim 2 claim 1, further comprising:
an attitude setting section which sets an attitude of the multi-joint manipulator in the specification point as a specification attitude,
wherein the calculating section generates the restrained control command value in the condition that the attitude of the multi-joint manipulator in the specification point is fixed on the specification attitude.

4. The control device according to claim 1, further comprising:
a specification joint setting section which sets any of the plurality of joints as a specification joint,
wherein the restrained condition is in the condition that an operation of the specification joint is fixed.

5. The control device according to claim 4, wherein the calculating section generates the restrained control command value in the condition that angles of all joints of the plurality of joints which are located on a distal end side from the specification joint are fixed in the multi-joint manipulator.

6. The control device according to claim 4, wherein the calculating section generates the restrained control command value in the condition that angles of all joints of the plurality of joints which are located on a base side from the specification joint are fixed in the multi joint manipulator.

7. The control device according to claim 1, wherein the specification point setting section is allowed to set a position on an object supported by the multi-joint manipulator as the specification point.

8. The control device according to claim 1, further comprising:
a displaying section which displays a simulation image of the multi joint manipulator,
wherein the specification point setting section sets the specification point based on an input operation to specify a viewpoint of the multi-joint manipulator in the simulation image by using a marker which specifies a position on a screen of the displaying section.

9. The control device according to claim 8, wherein object data acquisition processing of acquiring object data showing a shape of the object can be carried out based on a detection signal from a detecting device which detects the shape of the object supported by the multi joint manipulator,
wherein an object image showing the shape of the object is displayed as the simulation image in addition to the image of the multi-joint manipulator, and
the specification point setting section can set a position on the object image as the specification point.

10. A robot system comprising:
a multi-joint manipulator having a plurality of joints connected through links; and
a control device,
wherein the control device comprises:
a specification point setting section which sets a position except for a distal end as a specification point to the multi-joint manipulator;
a coordinate setting section which sets a specification position corresponding to the specification point and
a calculating section which generates a restrained control command value to control the multi joint manipulator in a restrained condition that at least one of degrees of freedom of movement the multi joint manipulator in the specification point is restrained, when a control command value to control the multi joint manipulator is given,
wherein the restrained condition is a condition that the multi-joint manipulator in the specification point is fixed on the specification position.

11. A method of generating control data for a multi joint manipulator which has a plurality of joints connected through links, comprising:
setting a position except for a distal end as a specification point to the multi joint manipulator;
setting a specification position corresponding to the specification point and
generating a restrained control command value to control the multi-joint manipulator in a restrained condition that at least one of degrees of freedom of movement of the multi-joint manipulator is restrained in the specification point, when a control command value to control the multi joint manipulator is given,
wherein the restrained condition is in a condition that the multi joint manipulator in the specification point is fixed to the specification position.

12. (canceled)

13. The method of generating control data according to claim 11, further comprising:
setting any of the plurality of joints as a specification joint,
wherein the restrained condition is in a condition that a movement of the specification joint is fixed.

14. (canceled)

15. A robot system comprising:
a multi-joint manipulator which has a plurality of joints connected through links;
a storage device which stores a program; and
a processing unit which execute the program to implement a control section which comprises:
a specification point setting section which sets a position except for a distal end as a specification point to the multi joint manipulator;
a coordinate setting section which sets a specification position corresponding to the specification point
a calculating section which generates a restrained control command value to control the multi-joint manipulator in a restrained condition that at least one of degrees of freedom of movement of the multi joint manipulator is restrained in the specification point, when a control command value to control the multi joint manipulator is given; and
a transmitting section which transmits the restrained control command value to the multi-joint manipulator,
wherein the restrained condition is a condition that the multi-joint manipulator in the specification point is fixed on the specification position.

16. A control device for a multi-joint manipulator which has a plurality of joints connected through links, comprising:
a specification point setting section which sets a position except for a distal end as a specification point to the multi-joint manipulator; and
a calculating section which generates a restrained control command value to control the multi joint manipulator in a restrained condition that at least one of degrees of freedom of movement the multi joint manipulator in the specification point is restrained, when a control command value to control the multi joint manipulator is given,
wherein the calculating section generates the restrained control command value in a condition that angles of all of joints on a distal end side from the specification point in the multi-joint manipulator are fixed or that angles of all of joints on a base side from the specification point are fixed.

17. The control device according to claim 16, wherein the calculating section generates the restrained control command value in the condition that the angles of all of the joints of the plurality of joints which are located on the distal end side from the specification joint are fixed in the multi-joint manipulator.

18. The control device according to claim 16, wherein the calculating section generates the restrained control command value in the condition that the angles of all of the joints of the plurality of joints which are located on the base side from the specification joint are fixed in the multi-joint manipulator.
